(19) United States
(12) Patent Application Publication
(10) Pub. No.: US 2024/0340770 A1
(43) Pub. Date: Oct. 10, 2024

(54) COMMUNICATION METHOD, FIXED REPRESENTATIVE NODE, REPLICA SERVER, MOBILE NODE AND POSITION MANAGEMENT SERVER

(71) Applicant: Nippon Telegraph and Telephone Corporation, Tokyo (JP)

(72) Inventors: Masafumi SHIMIZU, Musashino-shi, Tokyo (JP); Tomohiro KORIKAWA, Musashino-shi, Tokyo (JP); Kyota HATTORI, Musashino-shi, Tokyo (JP); Hidenari OWADA, Musashino-shi, Tokyo (JP); Naoki TAKAYA, Musashino-shi, Tokyo (JP)

(21) Appl. No.: 18/580,718

(22) PCT Filed: Jul. 30, 2021
(86) PCT No.: PCT/JP2021/028373

§ 371 Date: Jan. 19, 2024

(51) Int. Cl. H04W 40/38; H04W 28/02

(52) U.S. Cl. CPC H04W 40/38; H04W 28/0226

(57) ABSTRACT

A network system (hybrid network (10)) includes a fixed representative node (101, 102), includes a plurality of terminal-accommodating networks (mobile networks (20, 21)) that transfers communication data between terminals (mobile terminals (401, 402)), an adjacent mobile node enabled to communicate with the fixed representative node (101, 102), and mobile nodes (201 to 204) different from the adjacent mobile node, and includes an ad hoc network 31 whose network topology dynamically changes depending on a locational relationship between the mobile nodes. When receiving communication data from the terminal (mobile terminal (401)) to the terminal (mobile terminal (402)), the fixed representative node (101) transfers the communication data to the mobile node (201) that is the adjacent mobile node. In the ad hoc network 31, the communication data is transferred to the mobile node (204), transmitted to the fixed representative node (102), and further transmitted to the terminal (mobile terminal (402)).

### TECHNICAL FIELD

The present invention relates to a communication method, a fixed representative node, a replica server, a mobile node, and a location management server for connecting networks to each other by using an ad hoc network.

### BACKGROUND ART

As a communication service in a region where it is difficult to set up a line on the ground, there is a concept of a communication service using a satellite and a communication service using an airship or a solar plane resident in the stratosphere. In addition, there is a communication means that uses a drone or a balloon as a wireless base station instead of a disaster-stricken mobile phone wireless base station to provide a communication service to a disaster-stricken region.

When a satellite, an airship, or a balloon is referred to as an aerial node, communications of these are in a form of a ground node-an aerial node-a ground node, and a form of relaying a plurality of aerial nodes is not considered. In the case of a satellite, an airship, or a solar plane, since the aerial nodes moves, the network topology (communication path, transfer path of communication data) changes over time. For this reason, in communication in an aerial network including aerial nodes, it is necessary to dynamically determine a communication path. There is an ad hoc network as a communication network in which a communication path dynamically changes, and a plurality of routing protocols for determining a communication path are known (see Non Patent Literature 1).

### CITATION LIST

### Non Patent Literature

Non Patent Literature 1: Shiro Sakata et al., “Mobile Ad Hoc Networks and Wireless LAN Mesh Networks”, The Journal of the Institute of Electronics, Information and Communication Engineers B, Vol. J89-B, No. 6, pp. 811-823, 2006.

### SUMMARY OF INVENTION

### Technical Problem

To configure a hybrid network that connects networks on the ground instead of terminals on the ground via aerial nodes, it is necessary to determine not only communication paths in the aerial network but also communication paths combined with the networks on the ground.

The present invention has been made in view of such a background, and an object thereof is to enable connection between networks using an ad hoc network including moving nodes.

### Solution to Problem

To solve the above-described problem, a communication method according to the present invention is a communication method for a network system, in which the network system includes: a plurality of terminal-accommodating networks that transfers communication data between terminals; and an ad hoc network that includes a plurality of mobile nodes and whose network topology dynamically changes depending on a locational relationship between the mobile nodes, and each of the plurality of terminal-accommodating networks includes a fixed representative node, the ad hoc network includes an adjacent mobile node indicating one of the mobile nodes enabled to communicate with the fixed representative node and a mobile node different from the adjacent mobile node, and the fixed representative node executes: a step of, when receiving communication data from a terminal to be connected to one of the terminal-accommodating networks to which the fixed representative node belongs to a destination terminal that is a terminal to be connected to a terminal-accommodating network different from the one of the terminal-accommodating networks, acquiring identification information of a destination fixed representative node indicating a fixed representative node of a destination terminal-accommodating network that is a terminal-accommodating network to which the destination terminal is to be connected, and identification information of a destination mobile node indicating the adjacent mobile node of the destination fixed representative node, attaching the identification information of the destination mobile node and the identification information of the destination fixed representative node to the communication data received, and transferring the communication data to the adjacent mobile node; and a step of, when receiving communication data from the destination mobile node to the destination terminal to be connected to the one of the terminal-accommodating networks to which the fixed representative node belongs, transferring the communication data to the destination terminal, and each of the mobile nodes executes: a step of, when receiving the communication data of which the each of the mobile nodes is not the destination mobile node from a fixed representative node of which the each of the mobile nodes is the adjacent mobile node, or a mobile node different from the each of the mobile nodes, referring to a path table stored in the each of the mobile nodes and transferring the communication data to a mobile node of a next hop toward the destination mobile node; and a step of, when receiving the communication data of which the each of the mobile nodes is the destination mobile node from a fixed representative node of which the each of the mobile nodes is the adjacent mobile node, or a mobile node different from the each of the mobile nodes, transmitting the communication data to the destination fixed representative node attached to the communication data.

### Advantageous Effects of Invention

According to the present invention, it is possible to enable connection between networks using an ad hoc network including moving nodes.

### BRIEF DESCRIPTION OF DRAWINGS

FIG. 1 is an overall configuration diagram of a hybrid network according to a first embodiment.

FIG. 2 is a functional block diagram of a fixed representative node according to the first embodiment.

FIG. 3 is a functional block diagram of a mobile node according to the first embodiment.

FIG. 4 is a functional block diagram of a location management server according to the first embodiment.

FIG. 5 is a data configuration diagram of a mobile terminal location management table according to the first embodiment.

FIG. 6 is a data configuration diagram of a mobile node location management table according to the first embodiment.

FIG. 7 is a functional block diagram of a mobile terminal according to the first embodiment.

FIG. 8 is a sequence diagram of mobile terminal registration processing according to the first embodiment.

FIG. 9 is a sequence diagram of mobile terminal registration deletion processing according to the first embodiment.

FIG. 10 is a sequence diagram of adjacent mobile node detection processing according to the first embodiment.

FIG. 11 is a sequence diagram of communication data transfer processing (1) according to the first embodiment.

FIG. 12 is a sequence diagram of communication data transfer processing (2) according to the first embodiment.

FIG. 13 is a functional block diagram of a digital replica server according to a second embodiment.

FIG. 14 is a hardware configuration diagram illustrating an example of a computer that implements functions of the fixed representative node, the mobile node, the location management server, the mobile terminal, and the digital replica server according to the above-described embodiments.

### DESCRIPTION OF EMBODIMENTS

### <<Outline of Hybrid Network>>

Next, a description will be given of a communication method for a hybrid network (network system) in a mode (embodiment) for carrying out the present invention, and the like. The hybrid network includes a plurality of mobile networks (also referred to as terminal-accommodating networks) accommodating mobile terminals (terminals) and an ad hoc network. A node in a mobile network transfers communication data between mobile terminals connected to a mobile network, whereby communication between the mobile terminals is implemented.

The ad hoc network includes a plurality of mobile nodes. A fixed representative node is a node of a mobile network, and can communicate with any mobile node called an adjacent mobile node. In other words, the adjacent mobile node is a mobile node within a range in which communication from the fixed representative node is possible. Since the adjacent mobile node moves, the adjacent mobile node of the fixed representative node is replaced by another.

In a case where a mobile terminal (hereinafter, referred to as a transmission mobile terminal) communicates with a mobile terminal (hereinafter, referred to as a reception mobile terminal) accommodated in a mobile network different from a mobile network in which the transmission mobile terminal is accommodated, communication data for the reception mobile terminal is transferred to a fixed representative node of the mobile network in which the transmission mobile terminal is accommodated. The fixed representative node transmits communication data to an adjacent mobile node of the fixed representative node itself for transferring the communication data to a fixed representative node (hereinafter, referred to as a reception fixed representative node) of a mobile network in which the reception mobile terminal is accommodated. The communication data is transferred to an adjacent mobile node of the reception fixed representative node in the ad hoc network, and is transmitted from the adjacent mobile node to the reception fixed representative node. Further, the communication data is transferred in the mobile network from the reception fixed representative node to the reception mobile terminal, and received by the reception mobile terminal.

A hybrid network performs connection between mobile networks via an ad hoc network. By making a connection via an ad hoc network including mobile nodes such as a satellite, an airship, and a solar plane, it becomes possible to connect networks to each other, such as networks in regions scattered in a wide range or on the global scale, networks isolated due to disasters, and networks on mobile objects such as ships and aircraft, for which it is difficult to make connection by laying of a line on the ground. In addition, it becomes possible to suppress a communication delay to be low as compared with a case of repeatedly connecting a ground node and an aerial node to each other like a ground node-an aerial node-a ground node-an aerial node.

The network system of the present invention is called a hybrid network or a three-dimensional network because a conventional networks are connected to each other via a network in space or in the air. In the future, not only the network on the earth, but also a network capable of interstellar communication connecting ground networks of other planets and satellites to each other may be provided.

### <<First Embodiment: Overall Configuration>>

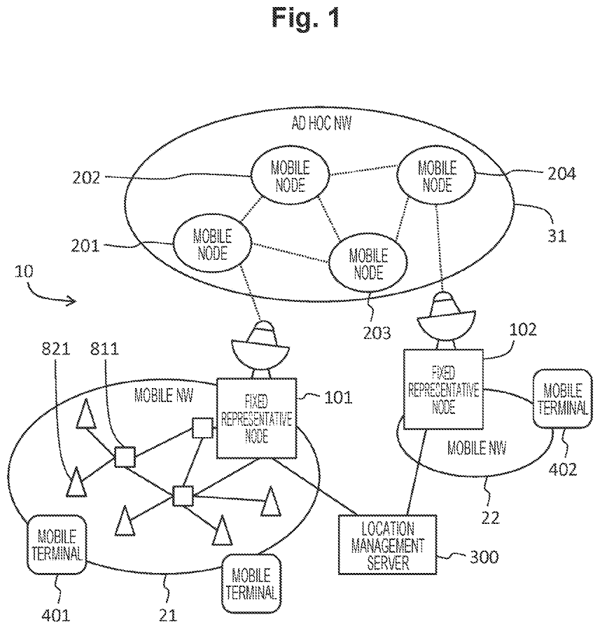

FIG. 1 is an overall configuration diagram of a hybrid network 10 (network system) according to a first embodiment. The hybrid network 10 includes mobile networks 21 and 22, an ad hoc network 31, and a location management server 300. In FIG. 1, the mobile networks 21 and 22, and the ad hoc network 31 are described as mobile NWs and an ad hoc NW, respectively.

The mobile network 21 is, for example, a mobile phone network, and includes a wireless base station 821 that directly communicates with a mobile terminal 401, a core node 811 that relays (transfers) communication data, and a fixed representative node 101, and enables communication between mobile terminals connected to the mobile network 21. Mobile terminals 401 and 402 are terminals that can move, and can be connected to any of the mobile networks 21 and 22. In addition, the mobile terminal 401 can move within a service area of each of the mobile networks 21 and 22 while changing a wireless base station to be connected.

The fixed representative node 101 of the mobile network 21 can communicate with any of mobile nodes 201 to 204 constituting the ad hoc network 31 to be described later. Similarly, the mobile network 22 includes a wireless base station (not illustrated) that directly communicates with the mobile terminal 402, a core node (not illustrated) that relays communication data between mobile terminals, and a fixed representative node 102.

The ad hoc network 31 includes the mobile nodes 201 to 204. The mobile nodes 201 to 204 relay communication data between the mobile terminals 401 and 402 connected to different mobile networks 21 and 22. For example, it is assumed that the fixed representative nodes 101 and 102 can respectively communicate with the mobile nodes 201 and 204. The communication data from the mobile terminal 401 to the mobile terminal 402 is transmitted from the mobile terminal 401, transferred in the mobile network 21 to the fixed representative node 101, and transmitted to the mobile node 201 by the fixed representative node 101. The communication data is then transferred between the mobile nodes 201 to 204 within the ad hoc network 31 to reach the mobile nodes 204. Subsequently, the communication data is transmitted from the mobile node 204 to the fixed representative node 102 and transferred from the fixed representative node 102 to the mobile terminal 402 in the mobile network 22.

The location management server 300 manages which mobile networks 21 and 22 the mobile terminals 401 and 402 are connected to. In addition, the location management server 300 manages which mobile nodes 201 to 204 the fixed representative nodes 101 and 102 can communicate with. The fixed representative nodes 101 and 102 can communicate with the location management server 300 not only through a line on the ground but also by using satellite communication, for example.

Hereinafter, the fixed representative nodes 101 and 102 are collectively referred to as fixed representative nodes 100, the mobile nodes 201 to 204 are referred to as mobile nodes 200, the mobile terminals 401 and 402 are referred to as mobile terminals 400, and the mobile networks 21 and 22 are referred to as mobile networks 20. Hereinafter, the fixed representative node 100, the mobile node 200, the location management server 300, and the mobile terminal 400 will be described in order.

### First Embodiment: Fixed Representative Node

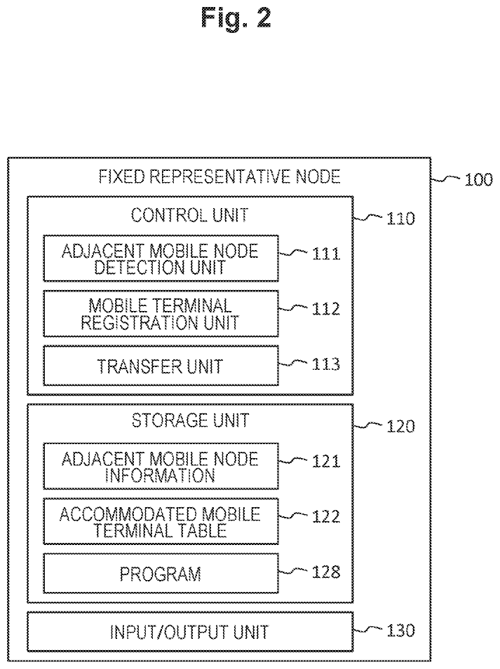

FIG. 2 is a functional block diagram of the fixed representative node 100 according to the first embodiment. The fixed representative node 100 is a computer, and includes a control unit 110, a storage unit 120, and an input/output unit 130. A communication device is connected to the input/output unit 130, and can communicate with a communication node and the mobile node 200 constituting the mobile network 20.

The control unit 110 includes a central processing unit (CPU), and includes an adjacent mobile node detection unit 111, a mobile terminal registration unit 112, and a transfer unit 113. The storage unit 120 includes storage devices such as a read only memory (ROM), a random access memory (RAM), and a solid state drive (SSD). The storage unit 120 stores adjacent mobile node information 121, an accommodated mobile terminal table 122, and a program 128.

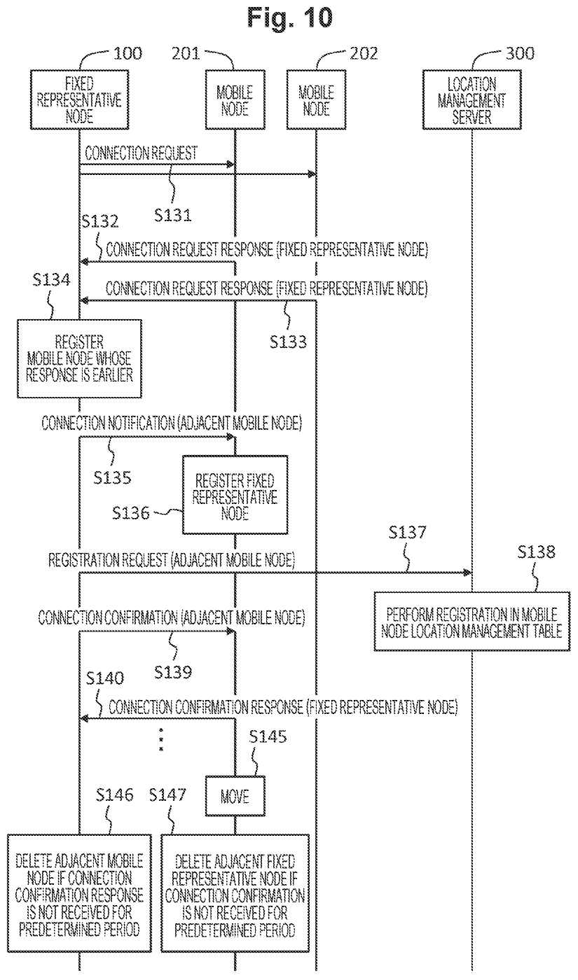

The adjacent mobile node detection unit 111 detects an adjacent mobile node that is the mobile node 200 enabled to communicate with the fixed representative node 100, and stores identification information (including an address) of the adjacent mobile node in the adjacent mobile node information 121 (see adjacent mobile node detection processing illustrated in FIG. 10 to be described later).

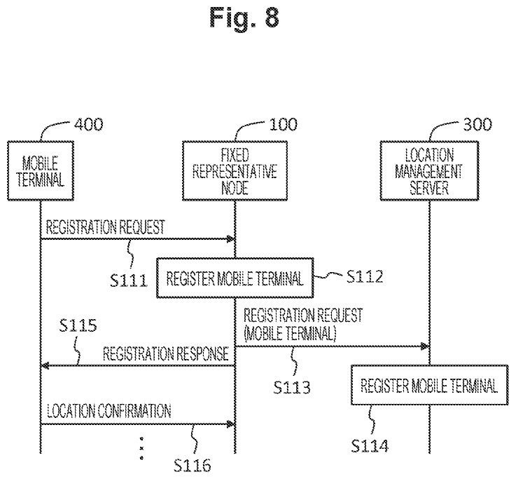

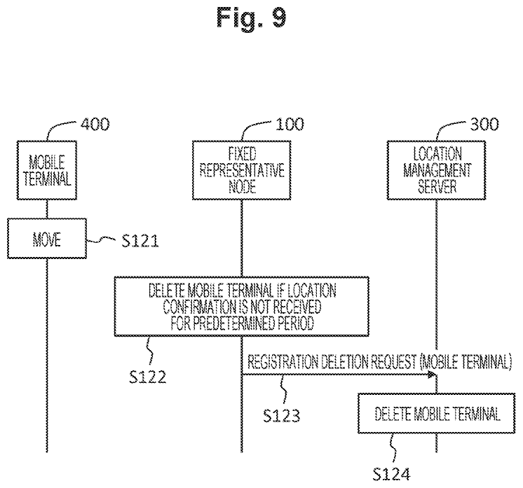

The mobile terminal registration unit 112 stores identification information of the mobile terminal 400 that has moved (has entered the service area) to the mobile network 20 where the fixed representative node 100 exists (belongs) in the accommodated mobile terminal table 122 (see mobile terminal registration processing illustrated in FIG. 8 to be described later). In addition, the mobile terminal registration unit 112 deletes identification information of the mobile terminal 400 that has exited from the mobile network 20 (service area) where the fixed representative node 100 exists from the accommodated mobile terminal table 122 (see mobile terminal registration deletion processing illustrated in FIG. 9 to be described later).

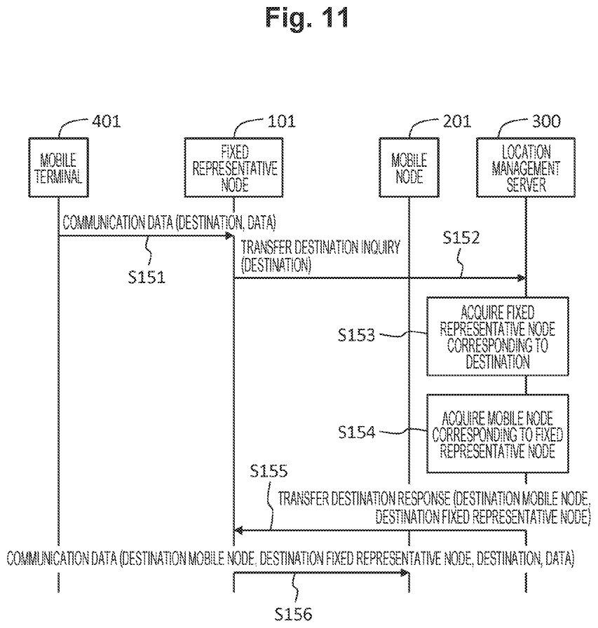

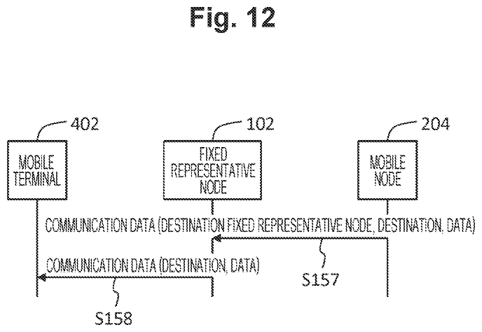

The transfer unit 113 transfers communication data between the mobile terminals 400 (see communication data transfer processing illustrated in FIGS. 11 and 12 to be described later).

The program 128 includes description of processing procedures such as the adjacent mobile node detection processing (see FIG. 10 to be described later), the mobile terminal registration processing (see FIG. 8 to be described later), the mobile terminal registration deletion processing (see FIG. 9 to be described later), and the transfer processing (see FIGS. 11 and 12 to be described later) executed by the fixed representative node 100.

### First Embodiment: Mobile Node

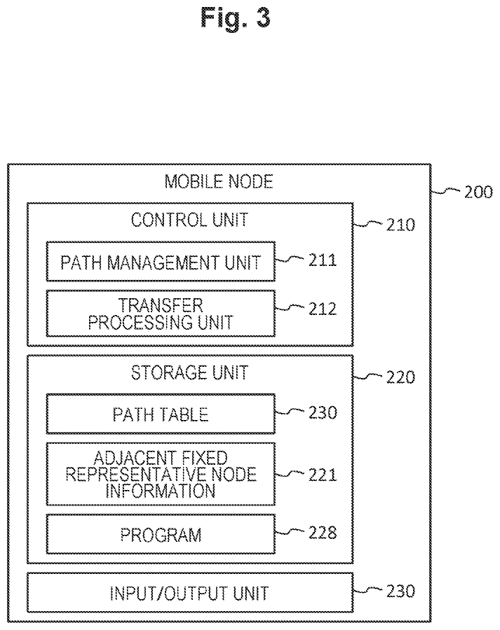

FIG. 3 is a functional block diagram of the mobile node 200 according to the first embodiment. The mobile node 200 is, for example, a solar plane or a communication satellite, and includes a mechanism and a control module for movement, but a configuration related to data communication will be described below.

The mobile node 200 as a communication node is a computer, and includes a control unit 210, a storage unit 220, and an input/output unit 230. A communication device is connected to the input/output unit 230, and can communicate with the fixed representative node 100 and another mobile node 200.

The control unit 210 includes a CPU, and includes a path management unit 211 and a transfer processing unit 212. The storage unit 220 includes storage devices such as a ROM, a RAM, and a flash memory. The storage unit 220 stores a path table 230 (routing table), adjacent fixed representative node information 221, and a program 228.

The path management unit 211 performs path control (path selection) processing in the ad hoc network 31. The path management unit 211 stores a transfer destination (next hop) of communication data obtained by the path control processing in the path table 230 (routing table). The path table 230 is a table in which a mobile node 200 to be a destination of communication data and a mobile node 200 to be a transfer destination of the communication data are associated with each other. Note that the path control processing may be known path control processing such as an Ad hoc On-demand Distance Vector algorithm (AODV), or may be path control processing matching characteristics of the mobile node 200. In addition, the path table 230 may be a table in which a fixed representative node 100 to be a destination of communication data and a mobile node 200 to be a transfer destination of the communication data are associated with each other.

In addition to the path control processing, the path management unit 211 performs the adjacent mobile node detection processing (see FIG. 10 to be described later) and stores identification information of an adjacent fixed representative node that is the fixed representative node 100 enabled to communicate with the mobile node 200 in the adjacent fixed representative node information 221.

The transfer processing unit 212 receives communication data from the adjacent fixed representative node or a mobile node 200, and if the destination is the adjacent fixed representative node, transmits the communication data to the fixed representative node 100. If the destination of the communication data is not the adjacent fixed representative node, the transfer processing unit 212 transfers the communication data to a mobile node 200 that is the next hop on the basis of the path table 230. In addition, in a case where the destination is not the fixed representative node 100 but a mobile node, and when the destination is not the mobile node 200, the transfer processing unit 212 refers to the path table 230 and transfers the communication data to a mobile node 200 that is the next hop. When the destination is the mobile node 200, the transfer processing unit 212 transmits the communication data to the adjacent fixed representative node that is the destination.

The program 228 includes description of processing procedures such as path control processing and transfer processing executed by the mobile node 200.

### First Embodiment: Location Management Server

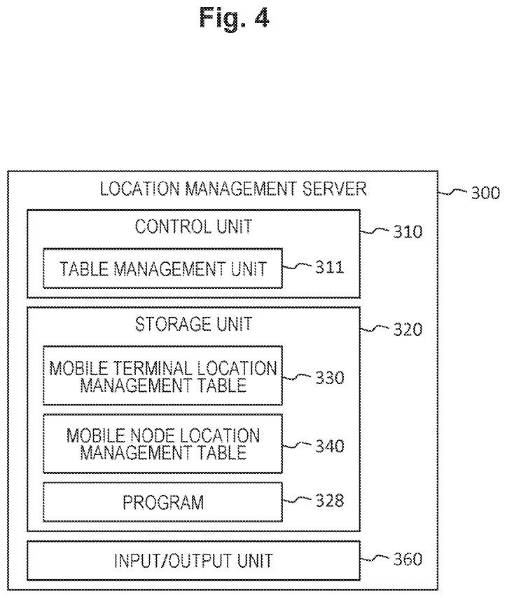

FIG. 4 is a functional block diagram of the location management server 300 according to the first embodiment. The location management server 300 is a computer, and includes a control unit 310, a storage unit 320, and an input/output unit 360. A communication device is connected to the input/output unit 360, and can communicate with the fixed representative node 100.

The control unit 310 includes a CPU and includes a table management unit 311. The storage unit 320 includes storage devices such as a ROM, a RAM, and an SSD. The storage unit 320 stores a mobile terminal location management table 330, a mobile node location management table 340, and a program 328.

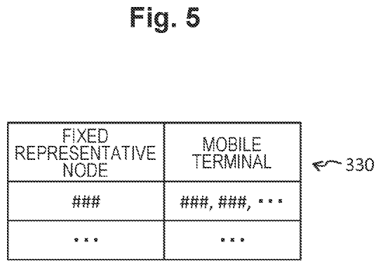

FIG. 5 is a data configuration diagram of the mobile terminal location management table 330 (terminal location management information) according to the first embodiment. In the mobile terminal location management table 330, the fixed representative node 100 and the mobile terminal 400 to be connected to the mobile network 20 in which the fixed representative node 100 is present are stored in association with each other.

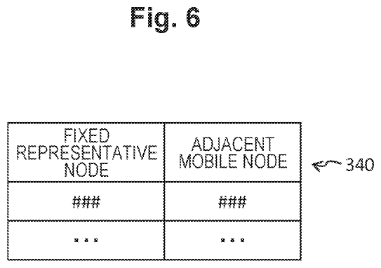

FIG. 6 is a data configuration diagram of the mobile node location management table 340 (mobile node location management information) according to the first embodiment. The mobile node location management table 340 stores the fixed representative node 100 and an adjacent mobile node of the fixed representative node 100 in association with each other.

Returning to FIG. 4, the table management unit 311 (location information management unit) updates the mobile terminal location management table 330 and the mobile node location management table 340 in response to a request from the fixed representative node 100 (see FIGS. 8, 9, and 10 to be described later). In addition, the table management unit 311 responds to an inquiry, from the fixed representative node 100, related to the fixed representative node 100 of the mobile network 20 to which the mobile terminal 400 is to be connected or an adjacent mobile node of the fixed representative node 100 (see FIG. 11 to be described later).

### First Embodiment: Mobile Terminal

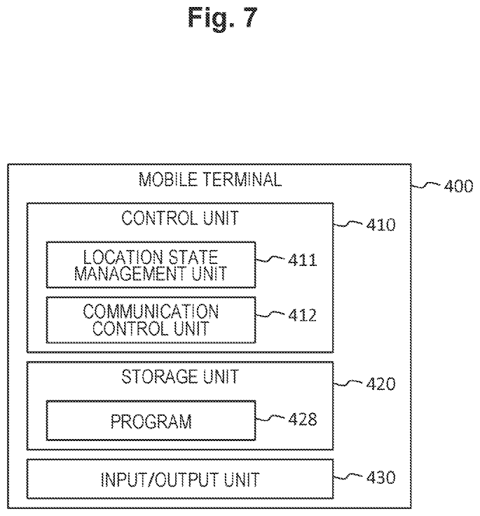

FIG. 7 is a functional block diagram of the mobile terminal 400 according to the first embodiment. The mobile terminal 400 is a computer, and includes a control unit 410, a storage unit 420, and an input/output unit 430. A communication device is connected to the input/output unit 430, and can communicate with the wireless base station 821 (see FIG. 1). In a case where two mobile terminals 400 are connected to the same mobile network 20, communication data exchanged between the mobile terminals 400 is relayed via a communication node in the mobile network 20 in a manner similar to that of an existing mobile phone network.

The control unit 410 includes a CPU, and includes a location state management unit 411 and a communication control unit 412. The location state management unit 411 executes processing (see the mobile terminal registration processing illustrated in FIG. 8 to be described later) when the mobile terminal 400 moves and connects to the mobile network 20. The communication control unit 412 performs communication data transmission and reception processing (see FIGS. 11 and 12 to be described later).

The storage unit 420 includes storage devices such as a ROM, a RAM, and a flash memory. The storage unit 420 stores a program 428 including description of processing procedures of the location state management unit 411 and the communication control unit 412.

Hereinafter, the mobile terminal registration processing, the mobile terminal registration deletion processing, the adjacent mobile node detection processing, and the communication data transfer processing will be described with reference to FIGS. 8 to 12.

### First Embodiment: Mobile Terminal Registration Processing

FIG. 8 is a sequence diagram of the mobile terminal registration processing according to the first embodiment. The mobile terminal registration processing is processing executed when the mobile terminal 400 moves and enters the service area of the mobile network 20.

In step S111, the location state management unit 411 of the mobile terminal 400 transmits a registration request message. The registration request message is transferred in the mobile network 20 to the fixed representative node 100. Note that, unless otherwise specified, various messages included in the following description include identification information of a transmission source even if not illustrated in the figure, and a communication node receiving the messages can identify the transmission source.

In step S112, the mobile terminal registration unit 112 of the fixed representative node 100 registers (stores) identification information of the mobile terminal 400 that is the transmission source of the received registration request message in the accommodated mobile terminal table 122.

In step S113, the mobile terminal registration unit 112 of the fixed representative node 100 transmits a registration request message including the identification information of the mobile terminal 400 to the location management server 300.

In step S114, the table management unit 311 of the location management server 300 registers pieces of the identification information of the fixed representative node 100 and the mobile terminal 400 included in the received registration request message in the mobile terminal location management table 330 (see FIG. 5). Specifically, the table management unit 311 adds the identification information of the mobile terminal 400 included in the registration request message to a column of the mobile terminal related to the fixed representative node 100 in the mobile terminal location management table 330.

In step S115, the mobile terminal registration unit 112 of the fixed representative node 100 transmits a registration response message to the mobile terminal 400.

In step S116, when receiving the registration response message, the location state management unit 411 of the mobile terminal 400 periodically transmits a location confirmation message to the fixed representative node 100 thereafter.

While receiving the location confirmation message, the fixed representative node 100 determines that the mobile terminal 400 is connected to the mobile network 20 and can communicate. In addition, while the mobile terminal 400 is connected to the mobile network 20 (stored in the accommodated mobile terminal table 122), other communication nodes (the core node 811 and the wireless base station 821 illustrated in FIG. 1) of the mobile network 20 transfer (relay) communication data of which the mobile terminal 400 is a transmission source/transmission destination in the mobile network 20.

### First Embodiment: Mobile Terminal Registration Deletion Processing

FIG. 9 is a sequence diagram of the mobile terminal registration deletion processing according to the first embodiment. The mobile terminal registration deletion processing is processing executed when the mobile terminal 400 moves out of the service area of the mobile network 20.

In step S121, the mobile terminal 400 moves out of the service area of the mobile network 20.

In step S122, if the location confirmation message (see step S116 in FIG. 8) from the mobile terminal 400 is not received for a predetermined period, the mobile terminal registration unit 112 of the fixed representative node 100 deletes the mobile terminal 400 from the accommodated mobile terminal table 122.

In step S123, the mobile terminal registration unit 112 of the fixed representative node 100 transmits a registration deletion request message including the identification information of the mobile terminal 400 to the location management server 300.

In step S124, the table management unit 311 of the location management server 300 deletes the identification information of the mobile terminal 400 included in the registration request message from the column of the mobile terminal related to the fixed representative node 100 in the mobile terminal location management table 330.

By the mobile terminal registration processing and the mobile terminal registration deletion processing, the fixed representative node 100 of a mobile network 20 to which the mobile terminal 400 is connected is registered in the mobile terminal location management table 330 of the location management server 300. In a case where the mobile terminal 400 is not connected to a mobile network 20 to which the fixed representative node 100 belongs (not in the accommodated mobile terminal table 122 of the fixed representative node 100), the fixed representative node 100 inquires of the location management server 300, thereby being able to acquire a fixed representative node 100 of a mobile network 20 that is a connection destination of the mobile terminal 400.

### First Embodiment: Adjacent Mobile Node Detection Processing

FIG. 10 is a sequence diagram of the adjacent mobile node detection processing according to the first embodiment.

In step S131, the adjacent mobile node detection unit 111 of the fixed representative node 100 broadcasts a connection request message toward the mobile nodes 200. In the following description, it is assumed that the mobile nodes 201 and 202 among the mobile nodes 200 have received the connection request message (have been within a range in which communication is possible).

In step S132, when receiving the connection request message, the path management unit 211 of the mobile node 201 broadcasts a connection request response message including identification information of the fixed representative node 100 that is a transmission source (as a transmission destination).

In step S133, the path management unit 211 of the mobile node 202 broadcasts a connection request response message as in step S132.

In step S134, the adjacent mobile node detection unit 111 of the fixed representative node 100 determines the mobile node 201 whose connection request response message is received earlier as an adjacent mobile node, and stores the adjacent mobile node in the adjacent mobile node information 121 (see FIG. 2).

In step S135, the adjacent mobile node detection unit 111 of the fixed representative node 100 broadcasts a connection notification message including identification information of the mobile node 201 determined as the adjacent mobile node in step S134.

In step S136, when receiving the connection notification message including the mobile node 201, the path management unit 211 of the mobile node 201 adds the identification information of the fixed representative node 100 that is the transmission source to the adjacent fixed representative node information 221, and registers the fixed representative node 100 as an adjacent fixed representative node. Note that the path management unit 211 of the mobile node 202 does not execute any processing since the received connection notification message does not include the mobile node 202.

In step S137, the adjacent mobile node detection unit 111 of the fixed representative node 100 transmits a registration request message including identification information of the mobile node 201 that is an adjacent mobile node to the location management server 300.

In step S138, the table management unit 311 of the location management server 300 registers the fixed representative node 100 and the mobile node 201 included in the received registration request message in the mobile node location management table 340 (see FIG. 6). Specifically, the table management unit 311 updates and registers a column of the mobile node related to the fixed representative node 100 in the mobile node location management table 340 with the identification information of the mobile node 201 included in the registration request message.

In step S139, the adjacent mobile node detection unit 111 of the fixed representative node 100 broadcasts a connection confirmation message including the identification information of the mobile node 201 that is the adjacent mobile node.

In step S140, when receiving the connection confirmation message including the mobile node 201, the path management unit 211 of the mobile node 201 broadcasts a connection confirmation response message including the identification information of the fixed representative node 100 that is the transmission source (as a transmission destination). Note that the path management unit 211 of the mobile node 202 does not execute any processing since the received connection confirmation message does not include the mobile node 202.

Thereafter, the adjacent mobile node detection unit 111 of the fixed representative node 100 and the path management unit 211 of the mobile node 201 periodically transmit and receive the connection confirmation message and the connection confirmation response message, and confirm that communication is possible (the mobile node 201 is at a location in which communication is possible as viewed from the fixed representative node 100).

Subsequently, a description will be given of processing when the mobile node 201 moves away from the fixed representative node 100 and communication with the fixed representative node 100 becomes impossible.

In step S145, the mobile node 201 moves, and communication with the fixed representative node 100 becomes impossible.

In step S146, if the connection confirmation response message is not received for a predetermined time, the adjacent mobile node detection unit 111 of the fixed representative node 100 deletes the mobile node 201 from the adjacent mobile node information 121. Subsequently, the adjacent mobile node detection unit 111 returns to step S131 and newly detects and registers an adjacent mobile node.

In step S147, if the connection confirmation message is not received for a predetermined time, the path management unit 211 of the mobile node 201 deletes the fixed representative node 100 from the adjacent fixed representative node information 221.

By the adjacent mobile node detection processing, the fixed representative node 100 and the mobile node 200 store and recognize communicable adjacent mobile node information 121 and communicable adjacent fixed representative node information 221, respectively. In addition, the location management server 300 grasps which fixed representative node 100 can communicate with which mobile node 200 (see the mobile node location management table 340 illustrated in FIG. 6).

Note that in steps S146 and S147, the adjacent mobile node detection unit 111 of the fixed representative node 100 and the path management unit 211 of the mobile node 201 determine that communication is impossible in a case where the connection confirmation message and the connection confirmation response message are not received for a predetermined period. Alternatively, the adjacent mobile node detection unit 111 and the path management unit 211 may determine that communication is impossible in a case where a signal strength at a time of message reception is lower than a predetermined value.

In step S134, the adjacent mobile node detection unit 111 of the fixed representative node 100 determines the mobile node 201 whose connection request response message is received earlier as the adjacent mobile node. Alternatively, the adjacent mobile node detection unit 111 may determine, as the adjacent mobile node, the mobile node 201 that is a source of the message having the strongest signal strength at the time of reception among the received messages.

### First Embodiment: Path Control Processing

The path control processing in the ad hoc network 31 is processing for determining a path of communication data to a target mobile node 200 in the ad hoc network 31. The path management units 211 of the mobile nodes 200 cooperatively perform the path control processing, so that each of the mobile nodes 200 acquires the path table 230 in which a transfer destination (next hop) of the communication data to the target mobile node 200 is stored. The path control processing in the ad hoc network 31 is, for example, AODV (Internet Engineering Task Force (IETF) Request for Comments (RFC) 3561). Note that the path table 230 may store a transfer destination of the communication data to a target adjacent fixed representative node.

### First Embodiment: Communication Data Transfer Processing

Hereinafter, the communication data transfer processing between the mobile terminals 401 and 402 will be described. Communicated data is divided into data of less than or equal to a predetermined size and transferred in the mobile network 20 and the ad hoc network 31. In a case where the mobile terminals 401 and 402 are connected to the same mobile network 20, communication data is transferred by the same method as a conventional (for example, an existing mobile phone network) method. Hereinafter, a description will be given of a case where the mobile terminals 401 and 402 are connected to the mobile networks 21 and 22, respectively, and the communication data is transmitted from the mobile terminal 401 to the mobile terminal 402. In addition, fixed representative nodes of the mobile networks 21 and 22 are the fixed representative nodes 101 and 102, respectively, and adjacent mobile nodes thereof are the mobile nodes 201 and 204, respectively (see FIG. 1).

FIG. 11 is a sequence diagram of communication data transfer processing (1) according to the first embodiment. FIG. 12 is a sequence diagram of communication data transfer processing (2) according to the first embodiment.

In step S151, the communication control unit 412 of the mobile terminal 401 transmits identification information of the mobile terminal 402 that is a destination and communication data including data to be communicated to the mobile network 21. A communication node of the mobile network 21 performs transfer to the fixed representative node 101 since the mobile terminal 402 that is the destination is not connected to the mobile network 21.

In step S152, the transfer unit 113 of the fixed representative node 101 transmits, to the location management server 300, a transfer destination inquiry message inquiring a transfer destination of the communication data to the mobile terminal 402 that is the destination. The transfer destination inquiry message includes the identification information of the mobile terminal 402 that is the destination.

In step S153, the table management unit 311 of the location management server 300 refers to the mobile terminal location management table 330 and acquires identification information of a fixed representative node corresponding to the destination in the received inquiry message. In this example, the fixed representative node corresponding to the mobile node 204 that is the destination is the fixed representative node 102.

In step S154, the table management unit 311 refers to the mobile node location management table 340 and acquires identification information of an adjacent mobile node corresponding to the identification information of the fixed representative node acquired in step S153. In this example, the adjacent mobile node of the fixed representative node 102 is the mobile node 204.

In step S155, the table management unit 311 transmits, to the fixed representative node 101, a transfer destination response message including the identification information of the fixed representative node (fixed representative node 102) that is the destination (transfer destination) acquired in step S153 and the identification information of the adjacent mobile node (mobile node 204) acquired in step S154.

In step S156, the fixed representative node 101 sets the adjacent mobile node received in step S155 as a destination, and transmits the communication data including a fixed representative node to be a destination, the destination of the communication data received in step S151, and the data to the mobile node 201 that is the adjacent mobile node of the fixed representative node 101.

In the ad hoc network 31, the communication data is transferred from the mobile node 201 to the mobile node 204 that is the destination. Specifically, a mobile node 200 refers to the path table 230 and transfers the communication data to a next hop corresponding to a destination mobile node. In a case where the destination mobile node is the mobile node 200, the mobile node 200 transmits the communication data to a fixed representative node that is the fixed representative node to be the destination and is also an adjacent fixed representative node. In this example, the mobile node 204 performs transmission to the fixed representative node 102 (see next step S157).

Moving on to FIG. 12, in step S157, the transfer processing unit 212 of the mobile node 204 transmits the communication data including the destination fixed representative node, the destination, and the data of the communication data transferred, to the fixed representative node 102 that is the destination fixed representative node.

In step S158, the transfer unit 113 of the fixed representative node 102 transmits the communication data including the destination and the data of the communication data received to the mobile terminal 402 that is the destination. The mobile terminal 402 is connected to the mobile network 22, and the communication data is transferred by the same method as the conventional method.

### First Embodiment: Features of Hybrid Network

The hybrid network 10 (network system) is a network in which the mobile networks 20 are connected to each other via the ad hoc network 31. Communication data between the mobile terminals 400 connected in the same mobile network 20 is transferred by a conventional communication method for the mobile network 20. Communication data between the mobile terminals 400 connected to different mobile networks 20 is transferred via the ad hoc network 31.

Communication between the mobile network 20 and the ad hoc network 31 is communication between a fixed representative node and an adjacent mobile node thereof. The adjacent mobile node is determined by the adjacent mobile node detection processing (see FIG. 10).

By making a connection via the ad hoc network 31 including the mobile nodes 200 such as a satellite, an airship, and a solar plane, it becomes possible to connect networks to each other, such as networks in regions scattered in a wide range or on the global scale, networks isolated due to disasters, and networks on mobile objects such as ships and aircraft, for which it is difficult to make connection by laying of a line on the ground.

### Modification According to First Embodiment: Mobile Network

The mobile network 20 is a mobile communication network such as a mobile phone network, but is not limited thereto, and may be a fixed terminal network such as a normal local area network (LAN). In such a case, a network to which a communication destination terminal is connected and a fixed representative node thereof are determined in advance (for example, an address of the network can be acquired from an address of the communication destination terminal), and the mobile terminal registration processing (see FIG. 8) and the mobile terminal registration deletion processing (see FIG. 9) are unnecessary. In addition, the mobile terminal location management table 330 (see FIG. 5) stored in the location management server 300 is also unnecessary.

There is Mobile IP (RFC 5944) that is an IETF standard as a communication protocol for implementing mobile communication. By a method similar to Mobile IP (by configuring the fixed representative node 100 to be a home agent (HA) and a foreign agent (FA) of Mobile IP), it becomes possible to support mobile communication even if there is no location management server 300.

Specifically, the HA is an agent in a home network to which a mobile terminal originally belongs. When the mobile terminal moves from the home network to a destination network, the FA of the destination network transmits a registration request of the mobile terminal to the HA. An address of the mobile terminal and an address of the FA are registered in the HA. When communication data for the mobile terminal reaches the home network, the HA transfers the communication data to the FA, and further, the FA transfers the communication data to the mobile terminal.

In the first embodiment, information on a destination of the mobile terminal (the mobile terminal location management table 330 illustrated in FIG. 5) is managed by the location management server 300, but in Mobile IP, the information is distributed and managed on the HA of the mobile terminal. For this reason, even if there is no location management server 300, a location of the mobile terminal can be managed, and it becomes possible to transfer the communication data for the mobile terminal to the destination.

### Second Embodiment

In the first embodiment, the mobile nodes 200 cooperatively perform the path control processing using, for example, AODV. If a location (path) of the mobile node 200 can be predicted, the mobile node 200 can determine a transfer path of communication data from the predicted location without performing the path control processing. In a second embodiment, a digital replica server 500 to be connected to any of the mobile networks 20 performs the path control processing.

In the second embodiment, the mobile node 200 acquires a location of the mobile node 200 and periodically transmits the location to an adjacent fixed representative node. The fixed representative node 100 transmits the received location of the mobile node 200 to the digital replica server 500 (replica server) to be described later. If the digital replica server 500 is connected to the mobile network 20 of the fixed representative node 100, the fixed representative node 100 may transmit the location of the mobile node directly or via the ad hoc network 31. In this way, the digital replica server 500 collects a history of locations of the mobile node 200.

In the second embodiment, a communication antenna included in a communication device included in the mobile node 200 is movable, and a direction of the communication antenna can be adjusted for each of communication partners (the mobile node 200 and the fixed representative node 100). The mobile node 200 transmits the communication data while adjusting the direction of the communication antenna. Note that the mobile node 200 may include a plurality of communication antennas, and transmit the communication data while selecting an optimal communication antenna for a communication destination.

### Second Embodiment: Digital Replica Server

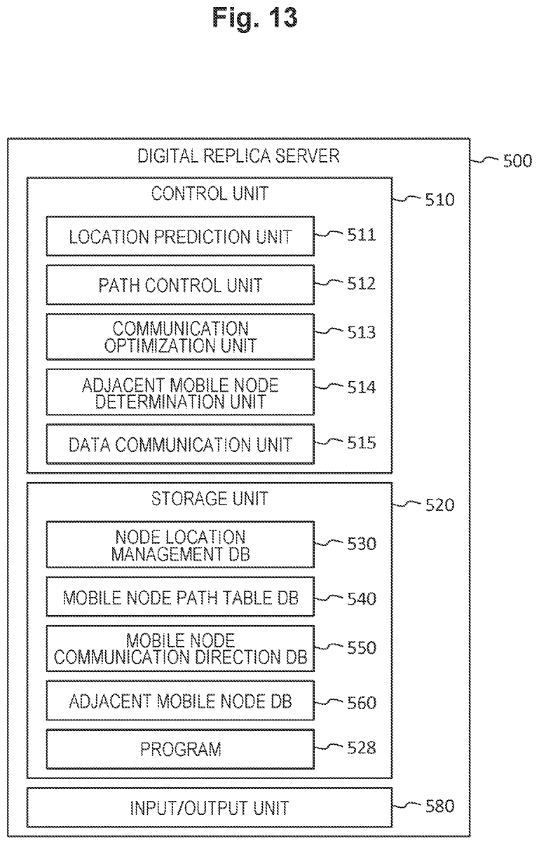

FIG. 13 is a functional block diagram of the digital replica server 500 according to the second embodiment. The digital replica server 500 is a computer, and includes a control unit 510, a storage unit 520, and an input/output unit 580. A communication device is connected to the input/output unit 580, and can communicate with a communication node, the mobile node 200, and the fixed representative node 100 constituting the mobile network 20.

The control unit 510 includes a CPU, and includes a location prediction unit 511, a path control unit 512, a communication optimization unit 513, an adjacent mobile node determination unit 514, and a data communication unit 515. The storage unit 520 includes storage devices such as a ROM, a RAM, and an SSD. The storage unit 520 stores a node location management database 530, a mobile node path table database 540, a mobile node communication direction database 550, an adjacent mobile node database 560, and a program 528. Note that, in FIG. 13, the node location management database 530, the mobile node path table database 540, the mobile node communication direction database 550, and the adjacent mobile node database 560 are described as a node location management DB, a mobile node path table DB, a mobile node communication direction DB, and an adjacent mobile node DB, respectively.

### Second Embodiment: Storage Unit of Digital Replica Server

The node location management database 530 stores a history of locations (coordinates) of each of the mobile nodes 200 and a predicted future location of each of the mobile nodes 200 predicted by the location prediction unit 511 to be described later. In addition, the node location management database 530 stores a location of the fixed representative node 100.

The mobile node path table database 540 stores a path table (see the path table 230 illustrated in FIG. 3) of each of the mobile nodes 200 calculated by the path control unit 512 to be described later.

The mobile node communication direction database 550 stores an optimal communication (communication antenna) direction of each of the mobile nodes 200 calculated by the communication optimization unit 513 to be described later.

The adjacent mobile node database 560 stores an adjacent mobile node for the fixed representative node 100 determined by the adjacent mobile node determination unit 514 to be described later.

The program 528 includes description of processing executed by the location prediction unit 511, the path control unit 512, the communication optimization unit 513, the adjacent mobile node determination unit 514, and the data communication unit 515.

### Second Embodiment: Data Communication Unit of Digital Replica Server

The data communication unit 515 stores the location of each of the mobile nodes 200 transmitted by the fixed representative node 100 in the node location management database 530. In addition, when a path table stored in the mobile node path table database 540 is updated, the data communication unit 515 transmits the path table to a corresponding mobile node 200. Specifically, the path table is transmitted to the fixed representative node 100 with which the digital replica server 500 can directly communicate without going through the ad hoc network 31, and subsequently transmitted from the fixed representative node 100 to the ad hoc network 31 and transferred to the corresponding mobile node 200. Alternatively, the data communication unit 515 may transmit a path table of a mobile node 200 to a fixed representative node 100 of which the mobile node 200 is an adjacent mobile node, and the fixed representative node 100 may transfer the path table to the mobile node 200. Note that the fixed representative node 100 of which the mobile node 200 is the adjacent mobile node can be acquired by referring to the adjacent mobile node database 560.

The path management unit 211 (see FIG. 3) of the mobile node 200 in the second embodiment does not perform the path control processing and stores the received path table in the path table 230. In other words, the path control processing is not executed in the ad hoc network 31, and instead, the path table that is a result of the path control processing executed in the digital replica server 500 is transmitted to the mobile node 200 and referred to when communication data is transferred.

When an optimal communication direction stored in the mobile node communication direction database 550 is updated, the data communication unit 515 transmits this data to a corresponding mobile node 200.

When the adjacent mobile node database 560 is updated, the data communication unit 515 transmits an updated adjacent mobile node to a corresponding fixed representative node 100. The adjacent mobile node detection unit 111 of the fixed representative node 100 (see FIG. 2) in the second embodiment does not perform the adjacent mobile node detection processing (see FIG. 10) and stores the received adjacent mobile node in the adjacent mobile node information 121.

### Second Embodiment: Location Prediction Unit of Digital Replica Server

The location prediction unit 511 predicts a future location on the basis of the history of the location of each of the mobile nodes 200 and stores the predicted future location in the node location management database 530. For the prediction, a known machine learning technique such as a neural network can be used. For example, if a machine learning model is used that has been trained on teaching data in which location information every 1 minute for 100 minutes is set as an explanatory variable and location information for the subsequent 20 minutes is set as an objective variable, the location prediction unit 511 becomes capable of predicting the location for up to 20 minutes from location information for the past 100 minutes. In other words, the location prediction unit 511 acquires past location information on the mobile node 200 and predicts a future location indicating a location after a predetermined time from a current time. The location prediction unit 511 may perform prediction using a time series model analysis (autoregressive, moving average) method in addition to the machine learning technique.

### Second Embodiment: Path Control Unit of Digital Replica Server

The path control unit 512 calculates a path table of each of the mobile nodes 200 on the basis of current locations of the mobile nodes 200 and future locations. Specifically, a distance between the mobile nodes 200 is predicted from locations of the mobile nodes 200, and on an assumption that communication is possible between the mobile nodes 200 within a predetermined distance, a path table (routing table) of each of the mobile nodes 200 is generated by executing the path control processing (for example, AODV), and stored in the mobile node path table database 540. In a case where a path table is changed, the data communication unit 515 transmits the path table to a corresponding mobile node 200.

### Second Embodiment: Communication Optimization Unit of Digital Replica Server

The communication optimization unit 513 calculates an optimal communication direction for each of communication partners (the mobile node 200 and the fixed representative node 100) of the respective mobile nodes 200 on the basis of locations of the mobile nodes 200 and the fixed representative nodes 100 in the node location management database 530, and stores the calculated direction in the mobile node communication direction database 550. In a case where a communication direction is changed, the data communication unit 515 transmits this data to a corresponding mobile node 200.

### Second Embodiment: Adjacent Mobile Node Determination Unit of Digital Replica Server

On the basis of locations of the mobile nodes 200 and the fixed representative nodes 100 in the node location management database 530, the adjacent mobile node determination unit 514 specifies a mobile node 200 at a location at which communication from a fixed representative node 100 is possible or at a location closest to the fixed representative node 100 as an adjacent mobile node of the fixed representative node 100. In a case where an adjacent mobile node is changed, the data communication unit 515 transmits the adjacent mobile node to a corresponding fixed representative node 100.

### Features of Second Embodiment

In the second embodiment, the digital replica server 500 performs the path control processing instead of the mobile node 200. For this reason, a load on the mobile node 200 can be reduced. In addition, the digital replica server 500 also calculates the optimal communication direction, and the mobile node 200 can communicate with another mobile node 200 and the fixed representative node 100 under an optimal condition. Accordingly, a communication error can be minimized, and power consumption reduction and communication efficiency improvement of the mobile node 200 become possible.

### Other Modifications

Although some embodiments of the present invention have been described above, these embodiments are merely examples and do not limit the technical scope of the present invention. The present invention can take various other embodiments, and various modifications such as omissions and substitutions can be made without departing from the gist of the present invention. These embodiments and modifications thereof are included in the scope and gist of the invention described in the present specification and the like, and are included in the invention described in the claims and the equivalent scope thereof.

### <<Hardware Configuration>>

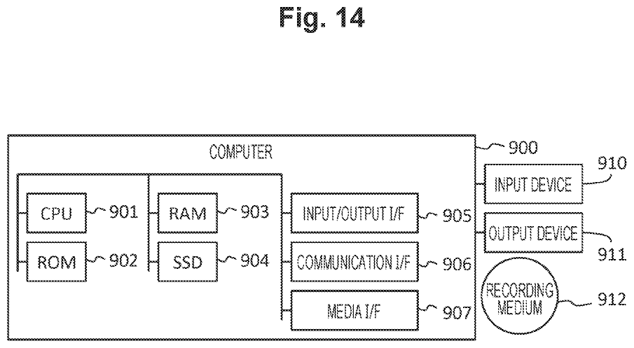

The fixed representative node 100, the mobile node 200, the location management server 300, the mobile terminal 400, and the digital replica server 500 according to the above-described embodiments are implemented by a computer 900 having a configuration as illustrated in FIG. 14, for example. FIG. 14 is a hardware configuration diagram illustrating an example of the computer 900 that implements functions of the fixed representative node 100, the mobile node 200, the location management server 300, the mobile terminal 400, and the digital replica server 500 according to the above-described embodiments. The computer 900 includes a CPU 901, a ROM 902, a RAM 903, an SSD 904, an input/output interface 905 (described as an input/output interface (I/F) in FIG. 14), a communication interface 906 (described as a communication I/F in FIG. 14), and a media interface 907 (described as a media I/F in FIG. 14).

The CPU 901 operates on the basis of a program stored in the ROM 902 or the SSD 904, and performs control by the control units 110, 210, 310, 410, and 510. The ROM 902 stores a boot program executed by the CPU 901 when the computer 900 is activated, a program related to hardware of the computer 900, and the like.

The CPU 901 controls an input device 910 such as a mouse and a keyboard and an output device 911 such as a display and a printer via the input/output interface 905. The CPU 901 acquires data from the input device 910 and outputs generated data to the output device 911 via the input/output interface 905.

The SSD 904 stores a program to be executed by the CPU 901, data to be used by the program, and the like. In addition, the communication interface 906 receives data from another device (not illustrated) via a communication network and outputs the data to the CPU 901, and transmits the data generated by the CPU 901 to another device via the communication network.

The media interface 907 reads a program or data stored in a recording medium 912 and outputs the program or data to the CPU 901 via the RAM 903. The CPU 901 loads the program from the recording medium 912 into the RAM 903 via the media interface 907, and executes the loaded program. The recording medium 912 is an optical recording medium such as a digital versatile disk (DVD), a magneto-optical recording medium such as a magneto optical disk (MO), a magnetic recording medium, a conductor memory tape medium, a semiconductor memory, or the like. Note that the input/output interface 905, the communication interface 906, and the media interface 907 correspond to the input/output unit 130, 230, 360, 430, and 580.

For example, in a case where the computer 900 functions as the fixed representative node 100, the mobile node 200, the location management server 300, the mobile terminal 400, and the digital replica server 500 according to the above-described embodiments, the CPU 901 of the computer 900 implements the functions of the fixed representative node 100, the mobile node 200, the location management server 300, the mobile terminal 400, and the digital replica server 500 by executing the programs 128, 228, 328, 428, and 528 loaded on the RAM 903. The CPU 901 reads the program from the recording medium 912 and executes the program. In addition, the CPU 901 may read the program from another device via a communication network, or may install the program from the recording medium 912 to the SSD 904 and execute the program.

### <<Effects>>

Effects of a communication method for a hybrid network (network system) and the like will be described below.

The network system (hybrid network 10) according to the above-described embodiments includes a plurality of terminal-accommodating networks (mobile networks 20) that transfers communication data between terminals (mobile terminals 400), and the ad hoc network 31 that includes the plurality of mobile nodes 200 and whose network topology dynamically changes depending on a locational relationship between the mobile nodes 200.

Each of the plurality of terminal-accommodating networks includes the fixed representative node 100. The ad hoc network 31 includes an adjacent mobile node indicating a mobile node 200 enabled to communicate with the fixed representative node 100 and a mobile node 200 different from the adjacent mobile node.

When the transfer unit 113 included in the fixed representative node 100 receives communication data from a terminal (mobile terminal 401) to be connected to a terminal-accommodating network (mobile network 21) to which the fixed representative node 100 belongs to a destination terminal (mobile terminal 402) that is a terminal connected to a terminal-accommodating network (mobile network 22) different from the terminal-accommodating network (mobile network 21), the transfer unit 113 acquires identification information of a destination fixed representative node (fixed representative node 102) that is a fixed representative node 100 of a destination terminal-accommodating network that is a terminal-accommodating network to which the destination terminal is to be connected, and identification information of a destination mobile node (mobile node 204) that is an adjacent mobile node of the destination fixed representative node, attaches the identification information of the destination mobile node and the identification information of the destination fixed representative node to the received communication data, and transfers the communication data to an adjacent mobile node (mobile node 201). In addition, when receiving communication data from the destination mobile node (mobile node 204) to the destination terminal (mobile terminal 402) connected to the terminal-accommodating network to which the fixed representative node 100 belongs, the transfer unit 113 transfers the communication data to the destination terminal.

When the transfer processing unit 212 included in the mobile node 200 receives communication data of which the mobile node 200 is not a destination mobile node, from the fixed representative node 100 of which the mobile node 200 is the adjacent mobile node or a mobile node 200 different from the mobile node 200, the transfer processing unit 212 refers to the path table 230 stored in the mobile node 200 and transfers the communication data to a mobile node 200 of a next hop toward the destination mobile node. In addition, when receiving communication data of which the mobile node 200 is a destination mobile node, from the fixed representative node 100 of which the mobile node 200 is the adjacent mobile node or a mobile node 200 different from the mobile node 200, the transfer processing unit 212 transmits the communication data to the destination fixed representative node attached to the communication data.

According to such a communication method for the network system (hybrid network 10), the terminal-accommodating networks (mobile networks 20) are connected with each other via the ad hoc network 31, and communication can be performed even between terminals (mobile terminals 400) connected to different terminal-accommodating networks. By making a connection via the ad hoc network 31 including the mobile nodes 200 such as a satellite, an airship, and a solar plane, it becomes possible to connect networks to each other, such as networks in regions scattered in a wide range or on the global scale, networks isolated due to disasters, and networks on mobile objects such as ships and aircraft, for which it is difficult to make connection by laying of a line on the ground.

The adjacent mobile node detection unit 111 of the fixed representative node 100 of the network system according to the above-described embodiments transmits a connection request to all the mobile nodes 200, and detects, as an adjacent mobile node, a mobile node 200 that has transmitted a connection request response received earliest among connection request responses that are responses to the connection request received from the mobile nodes 200.

When receiving the connection request from the fixed representative node 100, the path management unit 211 of the mobile node 200 transmits a connection request response to the fixed representative node 100.

According to such a communication method for the network system, the fixed representative node 100 can detect an adjacent mobile node of the fixed representative node 100. The adjacent mobile node moves, and communication is impossible if time passes. By including the adjacent mobile node detection unit 111, the fixed representative node 100 can communicate with any of the mobile nodes 200 and can communicate with the ad hoc network 31 at all times.

The network system includes the location management server 300.

When a terminal (mobile terminal 400) is connected to a terminal-accommodating network (mobile network 20), the mobile terminal registration unit 112 of the fixed representative node 100 transmits a registration request including identification information of the terminal to the location management server 300.

When detecting an adjacent mobile node, the adjacent mobile node detection unit 111 transmits a registration request including identification information of the adjacent mobile node to the location management server 300.

When the table management unit 311 of the location management server 300 receives the registration request including the identification information of the terminal from the fixed representative node 100, the table management unit 311 registers the identification information of the terminal in the terminal location management information (mobile terminal location management table 330) in association with identification information of the fixed representative node 100.

In addition, when receiving the registration request including the identification information of the adjacent mobile node from the fixed representative node 100, the table management unit 311 registers the identification information of the adjacent mobile node in the mobile node location management information (mobile node location management table 340) in association with the identification information of the fixed representative node 100.

Further, when receiving a transfer destination inquiry including identification information of a destination terminal from the fixed representative node 100, the table management unit 311 refers to the terminal location management information and acquires identification information of a destination fixed representative node corresponding to the identification information of the destination terminal, refers to the mobile node location management information and acquires identification information of a destination mobile node corresponding to the identification information of the destination fixed representative node, and returns the identification information of the destination mobile node and the identification information of the destination fixed representative node.

The transfer unit 113 of the fixed representative node 100 transmits the transfer destination inquiry including the identification information of the destination terminal to the location management server 300, and acquires the destination mobile node and the destination fixed representative node.

According to such a communication method for the network system, the fixed representative node 101 can specify the fixed representative node 102 of the terminal-accommodating network (mobile network 22) to which the destination terminal is to be connected and an adjacent mobile node (mobile node 204) thereof by inquiring of the location management server 300. The fixed representative node 101 can attach the fixed representative node 102 and the adjacent mobile node that are inquiry results to communication data and transmit the communication data to an adjacent mobile node (mobile node 201) of the fixed representative node 101, and accordingly, communication can be performed between terminal-accommodating networks.

The network system according to the above-described embodiment includes a replica server (digital replica server 500).

The location prediction unit 511 of the replica server acquires past location information on the mobile nodes 200 and predicts future locations indicating locations after a predetermined time from a current time.

The adjacent mobile node determination unit 514 of the replica server determines a mobile node 200 closest to the fixed representative node 100 as an adjacent mobile node from the predicted future locations of the mobile nodes 200 and a location of the fixed representative node 100.

The data communication unit 515 of the replica server transmits identification information of the adjacent mobile node determined by the adjacent mobile node determination unit 514 to the corresponding fixed representative node 100.

The adjacent mobile node detection unit 111 of the fixed representative node 100 receives and stores the adjacent mobile node received from the replica server. According to such a communication method for the network system, the replica server can detect an adjacent mobile node of the fixed representative node 100. Processing of detecting the adjacent mobile node by the fixed representative node 100 and the mobile node 200 is unnecessary, and a processing load and power consumption of the mobile node 200 can be reduced.

The path control unit 512 of the replica server according to the above-described embodiment executes the path control processing of determining a transfer path of communication data in the ad hoc network 31 on the assumption that two mobile nodes 200 are communicable to each other when the two mobile nodes 200 are within a predetermined distance, and generates a path table (see the path table 230) of each of the mobile nodes 200. The data communication unit 515 of the replica server transmits the path table to each corresponding mobile node 200 via the fixed representative node 100 of which the mobile node 200 is the adjacent mobile node.

According to such a communication method for the network system, the replica server can perform the path control processing for the ad hoc network 31. The path control processing by the mobile node 200 is unnecessary, and the processing load and power consumption can be reduced.

The fixed representative node 100 according to the above-described embodiments is a fixed representative node 100 of a network system including a plurality of terminal-accommodating networks (mobile networks 20) that transfers communication data between terminals (mobile terminals 400), and the ad hoc network 31 that includes the plurality of mobile nodes 200 and whose network topology dynamically changes depending on a locational relationship between the mobile nodes 200.

The fixed representative node 100 is connected to an adjacent mobile node that belongs to a terminal-accommodating network and indicates a mobile node 200 enabled to communicate with the fixed representative node 100.

When the transfer unit 113 included in the fixed representative node 100 receives communication data from a terminal (mobile terminal 401) connected to a terminal-accommodating network (mobile network 21) to which the fixed representative node 100 belongs to a destination terminal (mobile terminal 402) that is a terminal connected to a terminal-accommodating network (mobile network 22) different from the terminal-accommodating network (mobile network 21), the transfer unit 113 acquires identification information of a destination fixed representative node (fixed representative node 102) that is a fixed representative node 100 of a destination terminal-accommodating network that is a terminal-accommodating network to which the destination terminal is to be connected, and identification information of a destination mobile node (mobile node 204) that is an adjacent mobile node of the destination fixed representative node, attaches the identification information of the destination mobile node and the identification information of the destination fixed representative node to the received communication data, and transfers the communication data to an adjacent mobile node (mobile node 201). In addition, when receiving communication data from a mobile node 200 that is the destination mobile node (mobile node 204) to the destination terminal (mobile terminal 402) connected to the terminal-accommodating network to which the fixed representative node 100 belongs, the transfer unit 113 transfers the communication data to the destination terminal.

According to such a fixed representative node 100, communication can be performed even between terminals (mobile terminals 400) connected to different terminal-accommodating networks by connecting the terminal-accommodating networks and the ad hoc network 31 to each other.

The replica server (digital replica server 500) according to the above-described embodiment is a replica server of a network system (hybrid network 10) including a plurality of terminal-accommodating networks (mobile networks 20) that transfers communication data between terminals (mobile terminals 400), the ad hoc network 31 that includes the plurality of mobile nodes 200 and whose network topology dynamically changes depending on a locational relationship between the mobile nodes 200, and the replica server.

The replica server is communicatively connected to the fixed representative node 100 included in each of the plurality of terminal-accommodating networks and each of the plurality of mobile nodes 200.

The location prediction unit 511 of the replica server acquires past locations of the mobile nodes 200 and predicts future locations indicating locations after a predetermined time from a current time.

The adjacent mobile node determination unit 514 of the replica server determines a mobile node 200 closest to the fixed representative node 100 as an adjacent mobile node enabled to communicate with the fixed representative node from the predicted future locations of the mobile nodes 200 and a location of the fixed representative node 100.

The data communication unit of the replica server transmits the adjacent mobile node determined by the adjacent mobile node determination unit 514 to the corresponding fixed representative node 100.

According to such a replica server, it is possible to detect an adjacent mobile node of the fixed representative node 100. Processing of detecting the adjacent mobile node by the fixed representative node 100 and the mobile node 200 is unnecessary, and a processing load and power consumption of the mobile node 200 can be reduced.

The mobile node 200 according to the above-described embodiment is a mobile node 200 of a network system (hybrid network 10) including a plurality of terminal-accommodating networks (mobile networks 20) that transfers communication data between terminals (mobile terminals 400), and the ad hoc network 31 that includes the plurality of mobile nodes 200 and whose network topology dynamically changes depending on a locational relationship between the mobile nodes.

Each of the plurality of terminal-accommodating networks includes the fixed representative node 100. The ad hoc network 31 includes an adjacent mobile node indicating a mobile node 200 enabled to communicate with the fixed representative node 100 and a mobile node 200 different from the adjacent mobile node.

When the transfer processing unit 212 of the mobile node 200 receives communication data of which the mobile node 200 is not a destination mobile node indicating a mobile node 200 that is a destination, from a fixed representative node 100 of which the mobile node 200 is an adjacent mobile node or a mobile node 200 different from the mobile node 200, the transfer processing unit 212 refers to the path table 230 stored in the mobile node 200 and transfers the communication data to a mobile node 200 of a next hop toward the destination mobile node.

In addition, when receiving communication data of which the mobile node 200 is a destination mobile node from the fixed representative node 100 of which the mobile node 200 is an adjacent mobile node or a mobile node 200 different from the mobile node 200, the transfer processing unit 212 transmits the communication data to a fixed representative node 100 that is a destination attached to the communication data.

When receiving the connection request from the fixed representative node 100, the path management unit 211 of the mobile node 200 transmits a connection request response to the fixed representative node 100.

According to such a mobile node 200, communication data between terminals to be connected to different terminal-accommodating networks can be transferred via the fixed representative node 100, and communication between the terminals can be implemented.

The location management server 300 according to the above-described embodiment is the location management server 300 of a network system (hybrid network 10) including a plurality of terminal-accommodating networks that transfers communication data between terminals (mobile terminals 400), the ad hoc network 31 that includes the plurality of mobile nodes 200 and whose network topology dynamically changes depending on a locational relationship between the mobile nodes 200, and the location management server 300.

Each of the plurality of terminal-accommodating networks includes the fixed representative node 100, and the ad hoc network 31 includes an adjacent mobile node indicating a mobile node 200 enabled to communicate with the fixed representative node 100 and a mobile node 200 different from the adjacent mobile node.

When the table management unit 311 of the location management server 300 receives a registration request including identification information of a terminal from the fixed representative node of the terminal-accommodating network, the table management unit 311 registers, in the terminal location management information (mobile terminal location management table 330) of the storage unit 320, identification information of the fixed representative node 100 and the identification information of the terminal in association with each other.

When receiving a registration request including identification information of the mobile node 200 detected as the adjacent mobile node enabled to communicate with the fixed representative node 100 from the fixed representative node 100, the table management unit 311 registers, in the mobile node location management information (mobile node location management table 340) of the storage unit 320, the identification information of the fixed representative node 100 and identification information of the adjacent mobile node in association with each other.

In addition, when receiving a transfer destination inquiry including identification information of a terminal from the fixed representative node 100, the table management unit 311 refers to the terminal location management information and acquires the identification information of the fixed representative node 100 corresponding to the identification information of the terminal, refers to the mobile node location management information and acquires identification information of the adjacent mobile node corresponding to the identification information of the fixed representative node 100, and returns the identification information of the adjacent mobile node and the identification information of the fixed representative node 100.

Such a location management server 300 stores a fixed representative node 100 of a terminal-accommodating network to which a terminal is to be connected and an adjacent mobile node of the fixed representative node 100. In response to an inquiry about a transfer destination of communication data to a terminal that is not connected to the terminal-accommodating network to which the fixed representative node 100 belongs, the location management server 300 returns, as a response, a fixed representative node 100 to which the terminal is connected and an adjacent mobile node thereof. By obtaining the response, the fixed representative node 100 can attach information on the transfer destination to the communication data and transfer the communication data to the adjacent mobile node of the fixed representative node 100.

### REFERENCE SIGNS LIST

10 Hybrid network (network system)
20, 21, 22 Mobile network (terminal-accommodating network)
31 Ad hoc network
100, 101, 102 Fixed representative node
111 Adjacent mobile node detection unit
112 Mobile terminal registration unit
113 Transfer unit
200 to 204 Mobile node
211 Path management unit
212 Transfer processing unit
300 Location management server
311 Table management unit (location information management unit)
330 Mobile terminal location management table (terminal location management information)
340 Mobile node location management table (mobile node location management information)
400, 401, 402 Mobile terminal (terminal)
500 Digital replica server (replica server)
511 Location prediction unit
512 Path control unit
513 Communication optimization unit
514 Adjacent mobile node determination unit
515 Data communication unit

1. A network system comprising:
a plurality of terminal-accommodating networks that are configured to transfer transfers communication data between terminals; and
an ad hoc network that includes a plurality of mobile nodes and whose network topology dynamically changes depending on a locational relationship between the mobile nodes, and
each of the plurality of terminal-accommodating networks includes a fixed representative node, the ad hoc network includes an adjacent mobile node indicating one of the mobile nodes enabled to communicate with the fixed representative node and a mobile node different from the adjacent mobile node, and
the fixed representative node is configured to:
when receiving communication data from a terminal to be connected to one of the terminal-accommodating networks to which the fixed representative node belongs to a destination terminal that is a terminal to be connected to a terminal-accommodating network different from the one of the terminal-accommodating networks, acquire identification information of a destination fixed representative node indicating a fixed representative node of a destination terminal-accommodating network that is a terminal-accommodating network to which the destination terminal is to be connected, and identification information of a destination mobile node indicating the adjacent mobile node of the destination fixed representative node, attach the identification information of the destination mobile node and the identification information of the destination fixed representative node to the communication data received, and transfer the communication data to the adjacent mobile node; and
when receiving communication data from the destination mobile node to the destination terminal to be connected to the one of the terminal-accommodating networks to which the fixed representative node belongs, transfer the communication data to the destination terminal, and
each of the mobile nodes are configured to:
when receiving the communication data of which the each of the mobile nodes is not the destination mobile node from a fixed representative node of which the each of the mobile nodes is the adjacent mobile node, or a mobile node different from the each of the mobile nodes, refer to a path table stored in the each of the mobile nodes and transfer the communication data to a mobile node of a next hop toward the destination mobile node; and
when receiving the communication data of which the each of the mobile nodes is the destination mobile node from a fixed representative node of which the each of the mobile nodes is the adjacent mobile node, or a mobile node different from the each of the mobile nodes, transmit the communication data to the destination fixed representative node attached to the communication data.

2. The network system according to claim 1, wherein
the fixed representative node is configured:
transmit a connection request to all the mobile nodes; and
detect, as the adjacent mobile node, a mobile node that has transmitted a connection request response received earliest among connection request responses that are responses to the connection request received from the mobile nodes, and
each of the mobile nodes is configured to, when receiving the connection request from the fixed representative node, transmit the connection request response to the fixed representative node.

3. The network system according to claim 2, wherein
the network system further includes a location management server,
the fixed representative node is configured to:
when one of the terminals is connected to one of the terminal-accommodating networks, transmit a registration request including identification information of the one of the terminals to the location management server; and
when detecting the adjacent mobile node, transmit the registration request including identification information of the adjacent mobile node to the location management server,
the location management server is configured to:
when receiving the registration request including the identification information of the one of the terminals from the fixed representative node, register the identification information of the one of the terminals in association with identification information of the fixed representative node in terminal location management information in a storage unit;
when receiving the registration request including the identification information of the adjacent mobile node from the fixed representative node, register the identification information of the adjacent mobile node in association with the identification information of the fixed representative node in mobile node location management information in the storage unit; and
when receiving a transfer destination inquiry including identification information of the destination terminal from the fixed representative node, refer to the terminal location management information and acquire the identification information of the destination fixed representative node corresponding to the identification information of the destination terminal, refer to the mobile node location management information and acquire the identification information of the destination mobile node corresponding to the identification information of the destination fixed representative node, and return the identification information of the destination mobile node and the identification information of the destination fixed representative node, and
the fixed representative node is configured to transmit the transfer destination inquiry including the identification information of the destination terminal to the location management server and acquire the identification information of the destination mobile node and the identification information of the destination fixed representative node.

4. The network system according to claim 1, wherein
the network system includes a replica server,
the replica server is configured to:
acquire past location information on the mobile nodes,
predict future locations indicating locations after a predetermined time from a current time;
determine one of the mobile nodes closest to the fixed representative node as the adjacent mobile node from the predicted future locations of the mobile nodes and a location of the fixed representative node;
transmit the identification information of the adjacent mobile node to a corresponding fixed representative node, and
the fixed representative node executes
receive and store the identification information of the adjacent mobile node from the replica server.

5. The network system according to claim 4, wherein
the replica server is configured to:
determine a transfer path of communication data in the ad hoc network on an assumption that two of the mobile nodes are communicable to each other when the two of the mobile nodes are within a predetermined distance, and generating a path table of each of the mobile nodes; and
transmit the path table to each of the mobile nodes via a fixed representative node of which the each of the mobile nodes is an adjacent mobile node.

6. A fixed representative node of a network system including:
a plurality of terminal-accommodating networks that are configured to transfer communication data between terminals; and
an ad hoc network that includes a plurality of mobile nodes and whose network topology dynamically changes depending on a locational relationship between the mobile nodes,
the fixed representative node being connected to an adjacent mobile node that belongs to one of the terminal-accommodating networks and indicates one of the mobile nodes enabled to communicate with the fixed representative node,
the fixed representative node comprising a transfer unit that is configured to:
when receiving communication data from a terminal to be connected to one of the terminal-accommodating networks to which the fixed representative node belongs to a destination terminal that is a terminal to be connected to a terminal-accommodating network different from the one of the terminal-accommodating networks,
acquire identification information of a destination fixed representative node indicating a fixed representative node of a destination terminal-accommodating network that is a terminal-accommodating network to which the destination terminal is to be connected, and identification information of a destination mobile node indicating the adjacent mobile node of the destination fixed representative node,
attach the identification information of the destination mobile node and the identification information of the destination fixed representative node to the communication data received, and transfer the communication data to the adjacent mobile node, and
when receiving communication data from the destination mobile node to the destination terminal connected to the one of the terminal-accommodating networks to which the fixed representative node belongs, transfer the communication data to the destination terminal.

7. A replica server of a network system comprising:
a plurality of terminal-accommodating networks that are configured to transfer communication data between terminals;
an ad hoc network that includes a plurality of mobile nodes and whose network topology dynamically changes depending on a locational relationship between the mobile nodes; and
the replica server being communicatively connected to a fixed representative node included in each of the plurality of terminal-accommodating networks and each of the plurality of mobile nodes, and the replica server comprising:
a location prediction unit, including one or more processors, configured to acquire past location information on the mobile nodes and predict future locations indicating locations after a predetermined time from a current time;
an adjacent mobile node determination unit, including one or more processors, configured to determine one of the mobile nodes closest to the fixed representative node as an adjacent mobile node enabled to communicate with the fixed representative node from the predicted future locations of the mobile nodes and a location of the fixed representative node; and
a data communication unit, including one or more processors, configured to transmit identification information of the adjacent mobile node determined by the adjacent mobile node determination unit to a corresponding fixed representative node.

8. (canceled)

9. (canceled)
